(19) United States
(12) Patent Application Publication
(10) Pub. No.: US 2026/0095969 A1
(43) Pub. Date: Apr. 2, 2026

(54) DYNAMICALLY CHANGING POINT-TO-POINT NETWORK COMMUNICATION SYSTEM AND METHOD

(71) Applicant: MaiaEdge, Inc., Burlington, MA (US)

(72) Inventors: Patrick MeLampy, Dunstable, MA (US); Patrick Timmons, Natick, MA (US); Abilash Menon, Boxborough, MA (US)

(21) Appl. No.: 19/325,998

(22) Filed: Sep. 11, 2025

Related U.S. Application Data
(60) Provisional application No. 63/693,480, filed on Sep. 11, 2024.

(51) Int. Cl. H04W 76/19

(52) U.S. Cl. CPC H04W 76/19

(57) ABSTRACT

A network communication system and method provide a point-to-point connection (“PTP connection”) between a first site and a second site. To that end, the PTP connection includes an intermediate network device between the first and second sites, a first link from the first site to the intermediate network device, and a second link from the intermediate network device. The system and method then predict usage of the PTP connection, and dynamically change (e.g., in real-time or non-real time), as a function of predicting usage, the PTP connection by changing one or more of the first link, the intermediate network device, and the second link.

### CROSS-REFERENCE TO RELATED APPLICATION(S)

This patent application claims the benefit of U.S. Provisional Patent Application No. 63/693,480 entitled DYNAMICALLY CHANGING POINT-TO-POINT NETWORK COMMUNICATION SYSTEM AND METHOD filed Sep. 11, 2024, which is hereby incorporated herein by reference in its entirety.

### FIELD

Illustrative embodiments of the invention generally relate to network communications.

### BACKGROUND

Point-to-point networking is a method of establishing a direct connection between two network nodes, allowing for dedicated communication channels.

This approach is often used in scenarios where high-speed, low-latency connections are required or desired, such as in data centers or between critical infrastructure components. One of the significant drawbacks of point-to-point networking, however, is the tendency to over-reserve bandwidth. This means that the network allocates more bandwidth than is actually needed to ensure that the connection remains stable and performs well under peak load conditions.

Over-reserving bandwidth can lead to inefficiencies and unnecessary extra costs. When bandwidth is over-reserved, it means that a portion of the network's capacity is being held in reserve and not utilized, even during times of low traffic. This can result in higher operational costs, as network resources are not being used optimally. Additionally, it can lead to underutilization of the network, where other applications or services that could benefit from the available bandwidth are unable to access it due to the reservations in place.

### SUMMARY OF VARIOUS EMBODIMENTS

In accordance with one embodiment of the invention, a network communication system and method provide a point-to-point connection (“PTP connection”) between a first site and a second site. To that end, the PTP connection includes an intermediate network device between the first and second sites, a first link between the first site and the intermediate network device, and a second link coupled to the intermediate network device. The system and method then predict usage of the PTP connection, and dynamically change (e.g., in real-time or non-real time), as a function of predicting usage, the PTP connection by changing one or more of the first link, the intermediate network device, and the second link. Some embodiments may change the traffic profile based on prioritization.

It should be noted that the second link may connect to another intermediate network device, which itself has a third link to another network device (and even more intermediate network devices/links, or the second site). Alternatively, in a small network, the second link may connect to the second site.

There may be any of a number of manners for predicting usage, such as tracking usage of the PTP connection. The system and method also may use information relating to the type of data traffic to be used on the PTP connection. For example, the type of data may include bursty traffic. In that case, the system and method may dynamically change the PTP connection when bursty traffic and lower bandwidth traffic is predicted (they may use the same PTP connection). Among other ways, artificial intelligence and/or mathematical modelling may be used to determine an alternative PTP connection between the first and second sites.

To change the connection, some embodiments change to a second intermediate network device, and/or change to one or more of a plurality of additional links.

Some embodiments receive the PTP connection already established and manage it going forward. Other embodiments also may establish the PTP connection. The PTP connection preferably is bi-directional between the first and second sites. Among other things, the intermediate network device comprises a router or switch.

To establish and/or dynamically change, the system and method may add a path identifier into metadata of packets to be forwarded along the PTP connection. The identifier identifies the PTP connection. The system and method also may remove that path identifier at the intermediate network device before being forwarded to the destination (i.e., one or the first and second sites).

The PTP-connection may continue forwarding data between the first and second sites substantially without interruption during the process of dynamically changing the PTP connection. However, a path of last resort may be used when no path is available.

Some embodiments use a path database to establish and/or manage the PTP connection. To that end, the path database preferably provisions the PTP connection between the first site and the second site. The PTP connection may be a function of one or more of geolocation information, latency information, and anycast routing. Such information may be stored in the path database.

Some embodiments use Dijkstra techniques to dynamically change the PTP connection. Similar embodiments may sample PTP connection bandwidth and use Kurtosis techniques to determine that a dynamic path change is desired.

The PTP connection may be free of IP routing between the first site and the second site.

Illustrative embodiments of the invention are implemented as a computer program product having a computer usable medium with computer readable program code thereon. The computer readable code may be read and utilized by a computer system in accordance with conventional processes.

In accordance with another embodiment, a network communication system has a path computation engine configured to form a point-to-point connection (“PTP connection”) between a first site and a second site. As with the above noted embodiment, the PTP connection includes an intermediate network device between the first and second sites, a first link from the first site to the intermediate network device, and a second link from the intermediate network device. The system also has a prediction engine configured to predict usage of the PTP connection. The path computation engine is configured to dynamically change (e.g., as a function of predicting usage and/or in response to dynamic network expansions or contractions) the PTP connection by changing one or more of the first link, the intermediate network device, and the second link.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Those skilled in the art should more fully appreciate advantages of various embodiments of the invention from the following “Description of Illustrative Embodiments,” discussed with reference to the drawings summarized immediately below.

FIG. 1 schematically shows a high-level view of a forward Path that may be used to illustrate various embodiments.

FIG. 2 schematically shows a high-level view of a reverse Path in the network of FIG. 1.

FIG. 3 schematically shows how a simple network might appear in a graph database visually for just one router in various embodiments.

FIG. 4 is a color copy of Chart 1.

FIG. 5 is a color copy of Chart 2.

FIG. 6 is a color copy of Table 2.

### DESCRIPTION OF ILLUSTRATIVE EMBODIMENTS

The following terminology in Table 1 is used throughout this specification to describe certain embodiments as the context necessitates.

TABLE 1

| TERM | Definition |
|---|---|
| Site | This is a customer network location. Each Site |
| | has attributes including: |
| | Physical Location |
| | IP Address or CIDR definitions |
| | Segmentation Information (VLAN/IPSEC SA) |
| Path Router | A Path Router is a physical routing device |
| (RTR) | capable of Path Routing described in this |
| | document. Path Routers have attributes that |
| | include: |
| | Physical Location |
| | Physical Network Interface |
| | Fiber Network Information |
| External | An External Link is a point-to-point connection |
| Link (E-Link) | between a customer Site and a selected Path |
| | Router. External Links have attributes that |
| | include: |
| | State (In Service, Down, Maintenance) |
| | Link capacity |
| | Link Statistics |
| Internal | An Internal Link is a point-to-point connection |
| Link (I-Link) | between Path Routers. Internal Links have |
| | attributes that include: |
| | MAC Address (Pair - One on each side) |
| | Link state |
| | Link capacity |
| | Link stats |
| Path | A Path is a computed list of links that create |
| | a connection between two Sites. Paths have the |
| | following attributes. |
| | Unique ID |
| | Required Capacity |
| | Required Quality |
| | Guarantees |
| | Path stats |
| AI Path Computation | An AI-PCE utilizes advanced technology and |
| Engine (AI-PCE) | available training information to compute a |
| | path between two External Links. Inputs to |
| | the process include: |
| | Desired Maximum Bandwidth |
| | Desired Maximum Latency |
| | Desired level of QoS or bandwidth guarantees |
| | Lowest cost |
| Cloud Control | A cloud-based set of operational and control |
| Center (CCC) | servers to perform: |
| | Path Computation |
| | Collect and process training data |
| | Distribute Path specifications |

In illustrative embodiments, an AI based path computation engine (AI-PCE) aims to increase the utilization of network routers and fiber connections. More specifically, illustrative embodiments relate to a system and method for implementing paths across data networks that have end-to-end management. This implementation also may enable use of artificial intelligence (AI) training information about paths in real-time. After training, the AI-PCE can recompute paths to reduce core network resources. In some embodiments, this can increase core utilization from an average of 30% to 80% in core networks. The AI-PCE may run in the Cloud Control Center (CCC) or other device, which may be separate from the Path Routers (e.g., the Path Routers may report link state and other information to the AI-PCE running in the CCC, and the AI-PCE may compute routes and provide provisioning information to the Path Routers for forwarding packets using Path Identifiers rather than through traditional IP-based routing). Details of illustrative embodiments are discussed below.

A path in a network defines a set of interfaces and routers, virtually connecting one site or location to another. A Path is a network wide definition that can be changed at any time, consequently changing the actual pathways and routers in use. Data collected about Paths can be used to develop models used in optimization of paths in a recursive way. As a very simplistic example, consider two Paths that have mirror image data utilization (i.e., upstream/downstream) allowing perfect nesting. If the two paths were both 10 Mbs UP, 100 Mbs Down, but travelling in opposite directions, they could be combined. This would reduce the bandwidth required from 200 Mbs (2 100 Mbs bidirectional circuits) to an equivalent of two 110 Mbs circuits, resulting in a 90 Mbs savings.

Current network technology known to the inventors does not do this. To perform the AI training, one must be able to receive and process labelled data efficiently and have actionable controls over the network control points. The concept of an end-to-end path does not exist in a stateless packet forwarding network. IPv6 Segment Routing and MPLS-TE engineered pathways, for example, are based on Forward Equivalence Class, which essentially means an IP Address, and therefore are not dynamically manageable.

Various embodiments implement a modifiable end-to-end Path based network that, in some embodiments, also has embedded AI Training data collection. Rather than using AI, some non-AI solutions can be used or in conjunction with AI. Regardless of the technique used, data can be used to model paths, and update models of path in real time or non-real time. Some embodiments may model paths using digital twins that can be used to test paths and path changes, e.g., by making changes to the digital twin and analyzing expected results of those changes to determine an optimal set of changes for a given objective such as bandwidth utilization or cost. These models will permit nesting and improve efficiency. AI embodiments may be trained using an appropriate AI training algorithm, e.g., reinforcement learning with an appropriate reward function based on any of various objectives such as bandwidth utilization, cost, latency, etc.

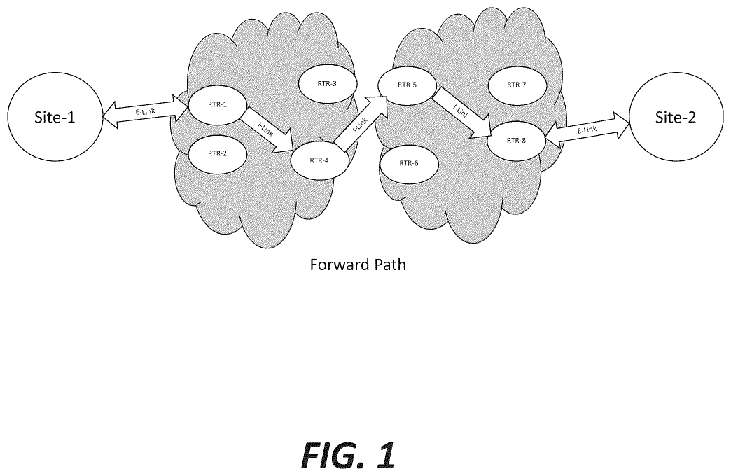

FIG. 1 schematically shows a high-level view of a Path in various embodiments. Preferably, this shows a point-to-point connection between two sites. As known by those in the art, in contrast with routing, a point-to-point connection typically has a logical connection between two Sites. In a point-to-point connection, the emphasis is on creating a dedicated or logical connection between two devices, whereas IP routing focuses on finding a path to the destination across potentially many routers. Moreover, a point-to-point connection implies a connection-oriented communication (whether physical or logical), whereas typical IP routing is typically connectionless and dynamic, with each packet potentially taking different routes to the same destination. This can include a dedicated path (e.g., leased line or VPN tunnel), while IP routing uses shared infrastructure, and packets from different connections may travel together through the same routers and links.

As shown, a path begins with a first Site, and traverses one or more Path Routers, terminating on a second Site. The path shown in that figure from Site-1 to Site-2 can be defined as a list of five Links:
1. Site-1 to RTR-1
2. RTR-1 to RTR-4
3. RTR-4 to RTR-5
4. RTR-5 to RTR-8
5. RTR-8 to Site-2

Each path can be described as a list of “from-to” Links. Each E-Link in this diagram is shown as a bidirectional Link. All I-Links are one-way Links. This allows the AI engines to look at directionality of data from various paths and combine them for optimization. E-Links are outside directional control and therefore must be bidirectional.

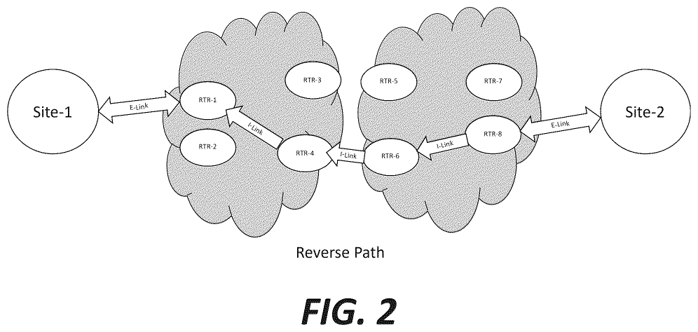

To connect Site-1 to Site-2, both a forward path shown in FIG. 1, and a reverse path shown in FIG. 2, are preferably allocated simultaneously. The reverse path shown in FIG. 2 can be defined as a list of five Links:
1. Site-2 to RTR-8
2. RTR-8 to RTR-6
3. RTR-6 to RTR-4
4. RTR-4 to RTR-1
5. RTR-1 to Site-1

Each path is independent and could change over time. For example, the forward path shown in FIG. 1 traverses RTR-5 while the reverse path shown in FIG. 2 traverses RTR-6. Generally, the forward Path E-Link is considered to be the owner of the Path and is the paying customer. These Paths operate like vectors, in that new packet flows can only traverse the forward direction. This action provides firewall like protections against unwanted sessions initiated from Site-2.

If Site-1 and Site-2 wish to initiate traffic to each other, then 4 paths would be used. In short, a path from Site 1 to Site 2 preferably will allocate a forward path ID and a reverse path ID. The forward path may be for initiator traffic and reverse path is for responder traffic. This is similar for Site 2.
1. Site-1 created forward path to Site-2
2. Site-1 created reverse path from Site-2
3. Site-2 created forward path to Site-1
4. Site-2 created reverse path from Site-2

The directionality and behavior of traffic based on initiator is an aspect of properly performing AI-PCE. The forward and reverse paths are calculated and deployed in pairs, but typically are independent in operation. The AI algorithms and path selection methods can be identical in either direction. For brevity, this disclosure discusses path calculation solely without a forward or reverse direction.

### Forwarding on a Path

Path Routers connected to Sites will perform complete classification of an inbound packet to determine what Path to select. In certain embodiments, the classification data to determine this includes any combination of:
Longest prefix of Destination IP Address
Longest prefix of Source IP Address
Protocol
Port
Interface
VLAN (Q-in-Q)
MAC Address

Path routers access a Path database (sometimes referred to herein as graph database or link database, although some embodiments may include separate path, link, and graph databases to store different types of information ultimately utilized to determine paths in various embodiments) to find a Path that has the best match for the inbound packet. This Path is pre-provisioned, and frequently updated by the AI-PCE which is disclosed in this document below. In certain embodiments, if no Path is found, the inbound packet is dropped, and security events are noted.

If a Path is found for the packet, then the Path Identifier (ID) is inserted into the packet as additional metadata, which optionally can include additional information such as the path type (e.g., primary vs. backup), path direction (e.g., forward vs reverse), packet priority, etc. The Path ID is important for any internal Path Router. In certain embodiments, every Path Router will have every known Path that references itself cached locally, and subscribe for any changes that may occur (including deletion). To perform high-speed forwarding of packets (often in the 10's of millions per second), the Path Router processes the Path information to reduce it to a simple forwarding action table. For example:

| Path Id | Next Hop |
|---|---|
| 1234 | Rtr 3 |
| 2345 | Rtr 4 |

To make the implementation more efficient, the Path Id may be configured to fit into the same content addressable memory used for packet routing. As understood in the art, a content addressable memory can be used to perform a fast search based on a value (which in this case would include the Path Id) to obtain the next hop (essentially requiring only one search operation regardless of the number of Path Ids). It should be noted that the additional metadata containing the Path Id can be encrypted on each link, e.g., using IPSec.

Each intermediate Path Router receives a packet on an incoming network interface and uses the Path Id and optionally other metadata in combination with the pre-provisioned forwarding information in the Path Database to determine the proper next-hop outgoing network interface for the packet. Thus, the packet can be forwarded using the Path Id rather than IP address or MPLS labels, which have more overhead and therefore can cause delays in processing and forwarding the packet.

When the last Path Router forwards the packet to the destination Site, the Path ID Metadata must be removed from the packet. However, the Path ID Metadata still identifies the Next Hop as the Site. This forwarding scheme thus delivers a packet that conforms to the classification on ingress Site to the destination Site unchanged.

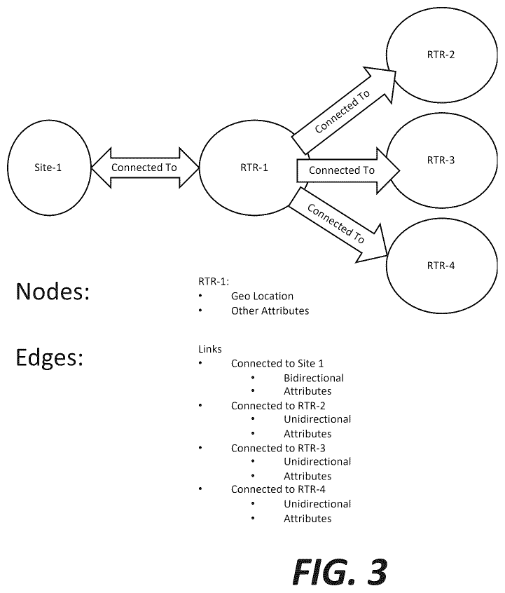

Illustrative embodiments model Path Routers and I-Links in a Graph Database. The Path Routers map to Nodes in a Graph Database, and the E-Links and I-Links map to Edges. Although not a requirement, using a Graph database has implementation advantages, and commercial Graph databases support Dijkstra algorithms for finding shortest paths through a network. FIG. 3 schematically shows how a simple network might appear in a graph database visually for just one router (i.e., RTR-1 in this example). Here, RTR-1 is connected to Site-1 and to routers RTR-2, RTR-3, and RTR-4 (relationships that are implied in FIGS. 1 and 2 by virtue of RTR-1, RTR-2, RTR-3, and RTR-4 being within the same network “cloud”).

Nodes and edges both have attributes. These attributes may be used during path selection. The attributes are stored in the Graph Database, making path computation simpler.

Attributes of Nodes may include, among other things:
Geolocation: This allows the database to be searched by location or physical distance when computing a path.
Operational State: This allows Nodes to be taken offline and or provisioned before use.
Capacity Measurements: This allows the AI-PCE to avoid Nodes that are out of memory, or reaching capacity in any dimension.
Cost.

Attributes of Edges may include, among other things, links and link attributes such as:
Directionality: Is the link unidirectional or bidirectional.
Available Bandwidth: This is the bandwidth on the point-to-point interface that can be allocated.
Allocated Bandwidth: This is the allocated bandwidth. This may be higher than the Available bandwidth due to oversubscription utilizing AI Methodology. The ratio of this to Available Bandwidth is the efficiency gain due to AI.
Cost: This is the true cost of using this link per Gigabyte of traffic. Each fiber or purchased transport will have different market costs.
Attributes: AI Labeled Data Sets including several types of data that can be used in calculation of oversubscription ratios, honoring guarantees, and QoS adherence. Additional attributes can identify Fiber/Carrier used to provide diversity guarantees when calculating backup pathways or routes.

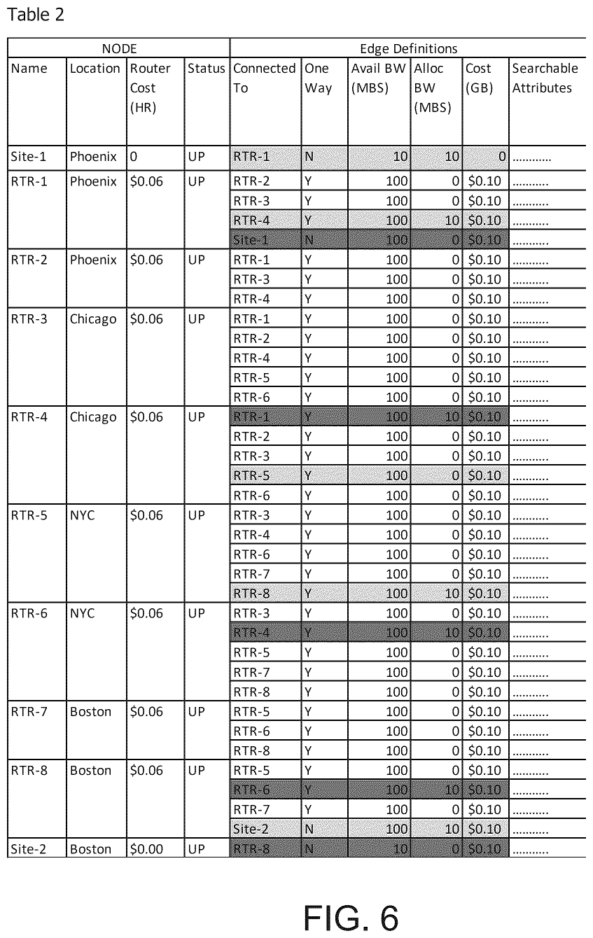

Table 2 shown in the attached drawings as “Table 2” in FIG. 6 shows one example of a Graph Database in accordance with illustrative embodiments consistent with the forward path shown in FIG. 1 and the reverse path shown in FIG. 2. Specifically, the Graph Database may have some or all of the information shown in Table 2.

As shown in Table 2, the Yellow Edges are the Links comprising the forward path (i.e., Site-1 to RTR-1, RTR-1 to RTR-4, RTR-4 to RTR-5, RTR-5 to RTR-8, RTR-8 to Site-2), and the Green Edges are the Links making up the reverse path (i.e., Site-2 to RTR-8, RTR-8 to RTR-6, RTR-6 to RTR-4, RTR-4 to RTR-1, RTR-1 to Site-1). Note here that there is an aspect of directionality to the links associated with each Node, e.g., the “next hop” Node for RTR-4 is RTR-5 for the forward path and RTR-1 for the reverse path, while the “next hop” Node for RTR-1 is RTR-4 for the forward path and Site-1 for the reverse path. Thus, a Node generally needs to know the path associated with each packet, which can be conveyed or derived in various ways such as using specific path information added to packets. Note that in this example, Allocated Bandwidth is 10 Mbs bidirectionally for the full pathway. This suggests no over subscription or benefits from path optimization at the point in time reflected in the Graph Database.

The Graph Database supports intelligent searches by attributes and edges. For example, even with a very large network, one could perform the following searches more easily:
Find all I-Links with bandwidth more than 100 Mbs of Bandwidth Available,
Find I-Links that connect to Router 6 that have latency less than 10 msec.

The graph database natively supports building a connection from Site to Site utilizing a Dijkstra approach (or other relevant approach), with one variable optimized at a time. This can be called recursively with differing variables being optimized, such as lowest latency, or lowest cost, or least busy. Having the correct attributes associated with the edges facilitates efficiency. The AI-PCE extensively queries the Graph Database when executing.

Sites are the starting and ending points of Paths. Sites are created through administrative actions. Sites exist prior to computation of Paths. Sites that start or originate a path may represent a commercial relationship with a paying customer. Both Sites in a Path could be both owned by one party, providing a point-to-point private connection for their exclusive use. Sites could also be owned by two different parties, where Site originating the traffic is commercially responsible, but the Site terminating must authorize the path establishment.

Sites are provisioned and have physically defined data that are used by the AI-PCE including, among other things:
Identity of Site (owner, name, contract number, etc.),
Type of Connection: Direct (i.e., Fiber) or Indirect (i.e., IPSEC),
Geographic Location of Site.

In certain embodiments, to provision a new path, an administrator on a graphical user interface (GUI) can draw a line from one site to another, connecting the two sites with a line. The line effectively acts as an arrow showing the direction of sessions establishment. The AI-PCE next may generate two paths:
Forward Path,
Reverse Path.

In certain embodiments, each of these Paths uses an identical algorithm. When a new Path is being provisioned, the actual bandwidth behavior is unknown. For a new Path, the only data known for initial Path Computation is:
Location of Originating Site
Location of Destination Site
Requested Bandwidth (Path Capacity)

Many purchasers of network bandwidth do not know their actual bandwidth needs. Inefficient, they often purchase more than they need. Accordingly, it would be more efficient to obtain an accurate measurement over time to gauge the true bandwidth (e.g., either more or less than requested).

In illustrative embodiments, to set up a path, a method uses an Initial Path Computation to locate the closest Path Router that has available capacity to handle the requested Paths bandwidth. Illustrative embodiments may use one or more of three techniques to enable a Site to select the closest Path Router.

Those may include:
Geolocation-based selection:
   Use IP geolocation to determine the client's approximate location,
   Calculate the geographic distance to each server,
   Select the server with the shortest distance.
Latency-based selection:
   Measure the round-trip time (RTT) from the client to each server,
   Choose the server with the lowest latency,
   This can be implemented using ping or small HTTP requests.
Anycast routing:
   Assign the same IP address to multiple servers in different locations,
   Let the network infrastructure route the client to the nearest server.

If directly connected using Fiber, the reachable Path Routers may be limited to just those that are located within a specific Fiber loop. Utilizing a database service, such as Connectbase, API's can be used for the AI-PCE to query:

1. Fiber availability: The platform allows a user to search for fiber availability at specific locations. The user can typically input an address or coordinates to see what fiber options are available nearby.

2. Service provider information: Connectbase can provide details on which service providers have fiber infrastructure or offer services in a given area. This can help populate the Fiber ID fields.

3. Capacity and specifications: In some cases, the user may be able to get information on the capacity and technical specifications of available fiber connections.

The entire population of Path Routers can also be queried by the AI-PCE. The Path Routers preferably are in the graph database, and can be searched by their attributes, including geolocation and fiber identifiers. Path Routers that are not in an operational state, or do not have enough available bandwidth, will be excluded.

If searching for a diversified backup path, the AI-PCE will also exclude Path Routers that do not have access to different Fiber IDs from the primary path. If there are multiple Path Routers nearby that remain in consideration, the AI-PCE can request that the Site send some test data packets to measure latency and possibly available bandwidth. This is generally a one-time test used to validate the External Link and to choose the one that is closest from a physical and network latency basis, although test data packets could be sent at other times such as to reevaluate Path Routers.

After the ingress or first Path Router is known, and the egress or last Path Router is known, if these two are not the same Path Router, a Dijkstra algorithm can be run to determine the shortest or lowest cost path between these routers. This path will be allocated twice, in forward direction and in a reverse direction, being careful to always have Adjusted Allocated bandwidth available.

After the full path is known, end-to-end attributes may be computed (e.g., latency). This also may be evaluated against a service level agreement (SLA), e.g., to ensure that the path can meet the required performance parameters such as bandwidth or latency. If the path cannot meet the required performance parameters, then the algorithm may be re-run. For example, if the latency is outside the required performance, the I-Link with the longest latency may be removed from the list, and the algorithm is re-run.

After having an acceptable primary Path, it may be desired to allocate a backup path that is ready to go (e.g., a “hot” backup). Ideally, the Backup path should not use any of the resources utilized by the primary Path. Thus, all of the Routers used in the primary path may be removed from consideration, and a backup path then can be determined utilizing the same exact process. However, in certain cases, if there are no substitute Path Routers at ingress or egress, then the ingress or egress routers may need to be included in identifying a Back-up path (i.e., if a particular site is only connected to a particular router, then that router cannot be removed from consideration), and similarly, if a particular router is required for all paths, then that router cannot be removed from consideration. For example, using the Path Database in Table 2, since Site-1 is only connected to RTR-1 and Site-2 is only connected to RTR-8, these routers cannot be removed from consideration. And since RTR-4 and RTR-5 are included in the primary path, these routers may be removed (at least initially) from consideration for the backup path. Thus, for example, using the Path Database in Table 2, a backup path might be defined as:

| | |
|---|---|
| 1. | Site-1 to RTR-1 |
| 2. | RTR-1 to RTR-3 |
| 3. | RTR-3 to RTR-6 |
| 4. | RTR-6 to RTR-8 |
| 5. | RTR-8 to Site-2 |

In this example, RTR-4 and RTR-5 might have been removed from consideration due to being included in the primary path of FIG. 1, although RTR-1 and RTR-8 could not be removed from consideration as RTR-1 is the only Path Router connected to Site-1 and RTR-8 is the only Path Router connected to Site-2.

Data gathering from the Path collected by the ingress Path Router is used to train the AI engines, assuming an AI solution is used. The path may be initially guaranteed at the bandwidth requested (e.g., 10 mbs). Any utilization of the Path will result in information being collected by the ingress Path Router. To protect customers' privacy, the data collected may simply include metadata about network usage. Two types of analytics preferably are collected on each path:
Short term bandwidth Timeseries data
Longer term bandwidth trends

As such, every Path in use will have different bandwidth behavior that is determined by the Path's specific applications (or collection of applications). Short term measurements that indicate burstiness can help gauge elasticity when combining with other paths, while long term bandwidth trends provide additional inputs into future variations (e.g., daily, weekly, and seasonal variations). Taken together, there is an opportunity for optimization not currently possible in the prior art known by the inventors.

It should be noted, however, that upstream and downstream paths each preferably perform this process independently, and have their AI-PCE computations completely independent of each other.

Some or all measurements used in training the AI-PCE may be time series data streams. In certain embodiments, data is sent (e.g., to the AI-PCE) for every path that is active, although lack of a report may indicate zero data for the period. All time series data collected by the Path Router preferably use the same time periods. For example, all of these data points could be measured over 5 seconds, and reported as a block of 12 measurements, covering 1 minute. The types of collected data may include some or all of:
Bandwidth: measured in Bytes per Second
Sessions: measured in new sessions per second. Alternatively, illustrative embodiments may send a count of active sessions, and not just the New Sessions.
Packets: measured as a count of packets per second.
Packet Loss: measured as a count of packets lost per second.
Burstiness: measured as a rolling measure of Bandwidth Kurtosis.

“Bursty” network traffic typically refers to data transmission that occurs in short, intense bursts rather than at a consistent, steady flow. This pattern is characterized by periods of high activity followed by periods of low or no activity, leading to fluctuations in network usage. Bursty traffic can cause congestion and affect network performance if not managed properly.

Many uses of the network can be highly bursty, while other uses are very consistent. For example, accessing a web page like cnn.com may result in a massive, short burst of traffic with over 70 TCP/IP sessions being established in a few seconds to various sources of information, AD trackers, etc., while a real time audio feed might have a very consistent and steady bandwidth rate. The AI-PCE engines will need a statistical indication of burstiness. There are many possible candidates for a measurement of burstiness of data traffic. Kurtosis is an example of a statistical measure that describes the shape of a probability distribution, specifically focusing on the “tailedness” of the distribution. It provides information about how prone a distribution is to outliers.

Illustrative embodiments are described herein using Kurtosis. Below is a breakdown:

1. What Kurtosis measures:
It quantifies whether the data are heavy-tailed or light-tailed relative to a normal distribution.
High kurtosis indicates a distribution with heavier tails and a higher, sharper peak.
Low kurtosis indicates a distribution with lighter tails and a lower, more rounded peak.

2. Interpretation in the context of bandwidth:
High kurtosis would suggest more frequent extreme values (very high or very low bandwidth usage).
Low kurtosis would indicate more consistent bandwidth usage, with fewer extreme spikes or drops.

3. Applicability to bandwidth variability:
Kurtosis can be very useful for characterizing the nature of bandwidth fluctuations.
It can help identify whether your network experiences frequent, extreme bursts of activity or more moderate, consistent usage patterns.

4. Calculation: The formula for kurtosis is: Kurtosis=[Σ(X−μ)\hat{ }4/n]/σ\hat{ }4 Where X is each value, μ is the mean, n is the number of values, and σ is the standard deviation.

5. Interpretation:
For a normal distribution, kurtosis is 3.
Kurtosis>3 indicates a leptokurtic distribution (heavy-tailed, more outliers).
Kurtosis<3 indicates a platykurtic distribution (light-tailed, fewer outliers).

In one example, the Path bandwidth may be sampled every second. The Kurtosis for the Path may be computed every minute, e.g., based on the previous 60 samples of Path bandwidth. A sample algorithm for calculating this is shown below.

```
  #include <math.h>
  double compute_kurtosis (double *bandwidth, int n) {
    double mean = 0.0, m2 = 0.0, m4 = 0.0;
    / / Compute mean
    for (int i = 0; i < n; i++) {
      mean += bandwidth[i];
    }
    mean /= n;
    / / Compute M2 and M4
    for (int i = 0; i < n; i++) {
      double diff = bandwidth[i] − mean;
      double diff_sq = diff * diff;
      m2 += diff_sq;
      m4 += diff_sq * diff_sq;
    }
    m2 /= n;
    m4 /= n;
    / / Compute kurtosis
    if (m2 != 0) {
      return (m4 / (m2 * m2) ) − 3.0;
    } else {
      return 0.0; / / To handle the case where all
values are the same
    }
```

This function calculates the excess kurtosis, which subtracts 3 from the result so that the normal distribution has a kurtosis of 0.

Below is an exemplary use of this function:

```
  #include <stdio.h>
  #define SECONDS 3600 / / For one hour of data
  int main( ) {
    double bandwidth[SECONDS];
    / / Fill the bandwidth array with your measurements
    / / For example:
    for (int i = 0; i < SECONDS; i++) {
      bandwidth[i] = /* your bandwidth measurement
for second i */;
    }
    double kurtosis = compute_kurtosis(bandwidth,
SECONDS);
    printf(“Kurtosis: %f\n”, kurtosis);
    return 0;
```

A few notes on interpreting the results:

1. A positive kurtosis indicates a heavy-tailed distribution (more outliers).

2. A negative kurtosis indicates a light-tailed distribution (fewer outliers).

3. The closer to zero, the more the distribution resembles a normal distribution.

For network bandwidth:
High positive kurtosis suggests frequent traffic spikes or bursts.
Low or negative kurtosis suggests more consistent bandwidth usage.

A customer's use of a Path may fluctuate over a longer period of time. Often there are peak periods during a day labeled “busy” hour. Often the peaks are caused by end-user activity, or scheduled machine-to-machine data transfers (e.g., backups). Bandwidth over large swaths of time (e.g., weeks or months) can create predictable usage patterns that resemble waves.

To model data traffic variations over time of day and day of week, illustrative embodiments consider several approaches. Those methods may include:

a. ARIMA (Autoregressive Integrated Moving Average): ARIMA models can be effective for time series data with clear trends and seasonality. Other variations include SARIMA (Seasonal ARIMA) or more advanced variants like ARIMAX (ARIMA with exogenous variables).

b. Prophet: Developed by Facebook, Prophet is designed to handle daily data with multiple seasonalities and holiday effects. It often is considered a good starting point for time series forecasting, particularly for business time series.

c. TBATS (Trigonometric, Box-Cox transform, ARMA errors, Trend, and Seasonal components): This model can handle complex seasonalities, which makes it suitable for data with both daily and weekly patterns.

d. Neural Networks: Recurrent Neural Networks (RNNs), particularly Long Short-Term Memory (LSTM) networks, have shown great promise in capturing complex patterns in time series data. They can be especially powerful if you have a large amount of historical data.

e. Gradient Boosting Models: Algorithms like XGBoost or LightGBM, when properly set up for time series forecasting, can capture complex non-linear relationships and handle multiple input variables effectively.

f. Transformer Models: Algorithms like TimesFM, a decoder-only foundation model, is pre-trained on a large and diverse time-series corpus, and is capable of generating forecasts for unseen datasets with variable prediction lengths. Like Large Language Models, transformer time-series models are based on the idea of self-attention. For time-series forecasting, transformers allow the model to learn the relationships between data and positional encoding to capture the temporal information in the data. Transformer models are scalable, generalizable, and interpretable, making them powerful tools for time-series forecasting.

Because each path in some embodiments has frequent time series measurements, and because centrally, some embodiments can access GPU resources if needed, one embodiment the inventors elected is the TimesFM approach, although the Recurrent Neural Network LSTM method is expected to function in a similar manner.

The TimesFM approach offers a pretrained model that can be fine-tuned. Each path will be able to generate a predicted future bandwidth for subsequent periods of time. These are predicted time series that are used to properly nest paths for maximum efficiency. Examples might include:

1. Bandwidth from a User Application Mixed with an Evening Backup

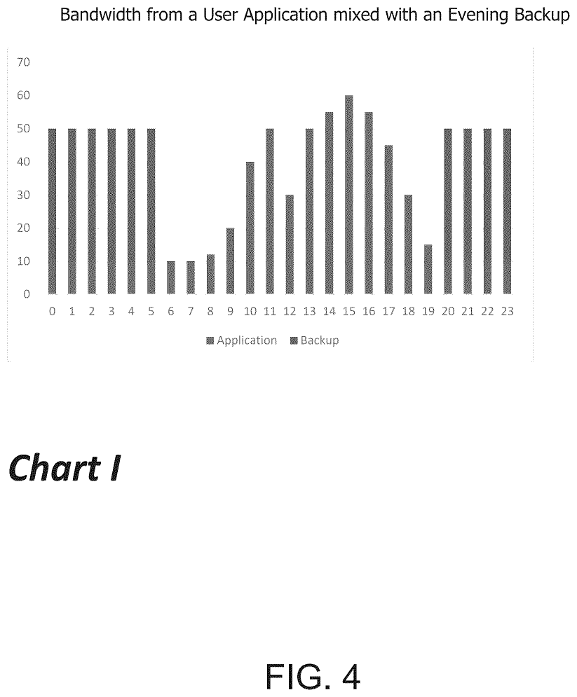

As shown in the attached drawings as “Chart 1” in FIG. 4, the application bandwidth during the time of 9 AM to 6 PM (i.e., 18 on the 24-hour clock) is much higher than at any other time of day, generating what is often called an “M” curve with two peaks occurring prior to lunch and mid-afternoon. In this example, the Backup application is a steady stream of data, starting at 8 PM (i.e., 20 on the 24-hour clock), and ending at 5 AM. These two applications “nest” nicely, maximizing usage of the core network.

### 2. US East Coast/West Coast Application Models:

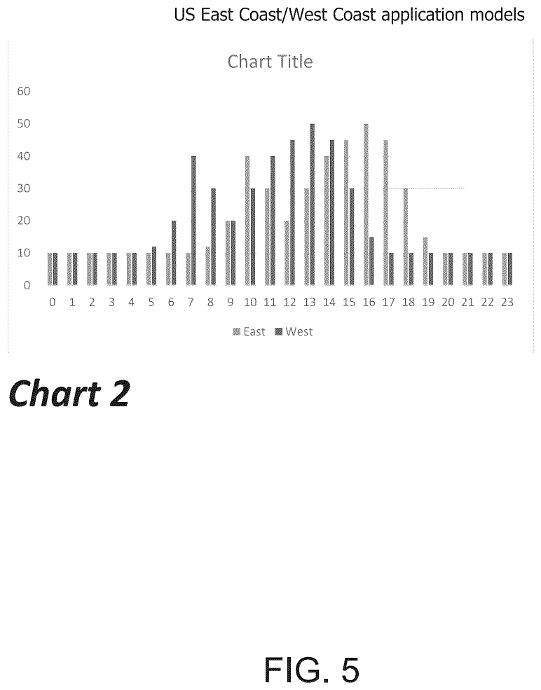

As shown in the attached drawings as “Chart 2” in FIG. 5, although not as pronounced, the usage patterns for these two user populations are virtually identical by time of day, but offset by three time zones.

Similar to Paths, each Path Router to Path Router Link also has the same time series measurements for each direction. The information preferably is for ALL bandwidth on the link. Accordingly, if two Paths are sending data on the same link, both are included in the time series results. The output of the training process is accessible through the Graph Database, with some summarizations to make the Graph Database Queries efficient. For example, searching for a Link that has bandwidth available over the next hour might be an efficient query, while applying the entire predictive model maybe reserved for fine tuning between two or three options.

An objective of the AI-PCE may be to allocate the optimum path with paths that mesh ideally well with each other, to get utilization higher on the core I-Links. In traditional networks, very little capability exists to associate stateless packet forwarding with learned behavior, and then to modify that behavior. Some of the most efficient core networks today often run at 30% of capacity due to such limitations. Illustrative embodiments aim to significantly increase that capacity, such as to double the efficiency of the core network. Each defined Path operates uniquely separate from all other Paths, and can be moved (either the forward or reverse direction) at any time. One limitation, however, is that the router connected to the Sites preferably has both the forward AND reverse path information.

The links report their time series data, and there is an aggregate model for each Link. These models are substantially identical to the models developed for the Paths. After the training data is recorded and actionable, the AI-PCE can look at the time series data and make adjustments to Paths, and continue to make adjustments over time to optimize the network. It should be noted that such adjustments can include scheduling a change for future implementation, e.g., scheduling a change to occur at a particular day/time in the future. To make an adjustment of any kind, Links are either included or excluded from the AI-PCE computation.

Examples of adjustments include:

1. Link is dropping packets: In this case, it would be advised to determine which path is also reporting dropped packets, and consider moving that Path to a different Link. In this case, the AI-PCE may recompute the path. Due to the dropped packets reported, the Link would automatically be pared back, and traffic would be placed onto other Links.

2. Aggregating Bursty Traffic: Another option moves a Path that has a high Kurtosis. It often is the significant outliers of bandwidth bursts that cause dropped packets. High Kurtosis users would likely perform better if they were on shared links as their bandwidth usage is very bursty in nature. The statistical likelihood of busts being at the same time is low. Applications that are bursty are designed to go as fast as possible, and frequently expect some dropped packets.

3. Link has available bandwidth a specific time periods: In this case, it would be useful to find a Path that has bandwidth utilization during the periods of availability. The AI-PCE would be encouraged to find longer term predictive bandwidth patterns that nest together nicely.

4. Path Costs are higher than target: If a path goes through too many Path Routers, it may be beneficial to try to reduce the number of links. In general, the least number of links is likely preferred. The capital costs of each Path Router should be minimized. The AI-PCE could also provide insight to where a new Path Router should be deployed to lower costs.

An AI Path Computation Element (AI-PCE) is a network component, application, or node capable of computing a network path or route based on a network graph and applying computational constraints. Below is a brief overview of how one embodiment of the AI-PCE operates:

1. Network Topology Information:
The AI-PCE accesses the graph database to get an up-to-date detailed view of the network topology, including nodes, links, and their attributes. Path Routers register all of their Links with the graph database and continually update the attributes.
For each Path, the AI Forecast is generated and stored in the Path Database
For each Internal Link, the AI Forecast is generated and stored in the Link Database.

2. Path Computation Requests:
The provisioning of a new Path automatically generates a Path Computation Request.
Link Down events will automatically initiate a new Path Computation Request.
Link Up events (after a debouncing delay) will initiate a new Path Computation Request.
Training Data Thresholds: While collecting training data, if a threshold is crossed (either too high or too low) a Path Computation Request will be initiated.
Elapsed Time: If the AI-PCE has been quiescent for a period of time, a Path Computation Request will be initiated.

3. Constraint-Based Path Computation:
Using the network topology information, the AI-PCE applies various algorithms to compute the optimal path.
The AI-PCE takes into account the specified constraints, which might include bandwidth requirements, maximum latency, link utilization, or other quality of service (QoS) parameters.

4. Algorithm Application:
The PCE uses sophisticated algorithms, often based on shortest path algorithms like Dijkstra's, but with additional constraints and optimizations.
It may use techniques like Constrained Shortest Path First (CSPF) to find paths that meet all specified requirements.
The AI-PCE may iterate changing constraints from cost to latency. The best Links with the best Nesting will be chosen.
Paths that have a high Kurtosis (bursty traffic) will always be grouped together, if possible, while paths with a lower Kurtosis will be grouped together.
Step 1: Determine all of the I-Links that are options for use this path. This essentially is a spanning tree between the Sites.
Step 2: Using the bandwidth requirement, eliminate any I-Links that have insufficient bandwidth.
Step 3: If the Path exhibits high kurtosis, then fork other path selection to select I-Links reserved for bursty traffic.
Step 4: Calculate a nesting efficiency index for each I-Link. By adding the two future forecasts, illustrative embodiments can measure how efficient the I-Link would be, resulting in an efficiency index.
Step 5: Using the graph database's Dijkstra algorithm, calculate the path constrained by cost to get a list of I-Links—NOTE: The I-Links preferable are a subset of the results of Step 4.
Step 6: Using the path calculated in Step 5, walk the path finding the minimum efficiency index (least efficient nesting). If this is below a target threshold, remove the I-Link from the list of available I-Links, and return to Step 5.
Step 7: Continue to repeat Step 5 and Step 6 until there is no solution. Keep a list of all discovered paths, and their minimum efficiency. The last path that was discovered should have the best efficiency.
Step 8: Review the chosen path for attributes (e.g., QoS, Latency, Cost, etc.). If the path is insufficient, revisit the list of discovered paths in reverse order checking each of them for compliance. The first path that is compliant is the best path.
Step 9: If there is a current path, compare anticipated efficiency, cost, and latency with the current path in use. If the path efficiency is not more than a minimum improvement threshold, then we revert to the current path.

It should be noted that this process is simplified from a longer process that normally may be used. Accordingly, in practice, the process likely has many steps that those skilled in the art likely would use. In addition, some of the steps may be performed in a different order than that shown, or at the same time. Those skilled in the art therefore can modify the process as appropriate.

When an existing path is updated, all of the Routers that are involved in the New Path preferably immediately receive the new Path information. Path Routers cache all Path definitions for efficiency. Path Routers that are no longer part of a Path have their subscriptions for the path torn down, thus notifying them that they can remove the Path information from their Caches.

Every Path Router preferably will have received all Path information that is required. And when changes occur, the Path Routers will receive all changes, modifications, and deletions of Paths from their localized cache.

In a large network, the exact delivery of new path information may arrive at different nodes (Path Routers) at different times. This may result in a large number of packets momentarily not having an available Path. This transient instability is also very much a part of large IP Networks when route changes cause momentary instability.

To resolve this situation, various embodiments may have a path of last resort. For example, every Router/Node may have a completely resolved best Path of Last Resort to every other Router Node. If a packet arrives at a Path Router, and the Path ID is extracted from the packet, but the Path no longer is specifying this Router as part of the path, the Router will instead forward the packet using its “last resort forwarding table.” The AI-PCE builds the Paths of Last resort automatically, and installs them. These paths are also maintained and updated, preferably every time the AI-PCE runs to recompute the entire network.

To make things more efficient, when the Path Router no longer is part of a Path, and a packet arrives, it simply looks up the Path, determines the terminating Path Router, and forwards the packet upon this pathway of last resort.

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., various logic flows described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads. Software systems may be implemented using various architectures such as a monolithic architecture or a microservices architecture.

It should be noted that terms such as “computer,” “client device,” “server,” “server system,” and “processor” may be used herein to describe devices or systems that may be used in certain embodiments of the present invention and should not be construed to limit the present invention to any particular device or system type unless the context otherwise requires. Thus, a device or system may include, without limitation, a bridge, router, bridge-router (brouter), switch, node, server, computer (including desktop, laptop, tablet, portable, wearable, etc.), cloud computing platform, appliance, or other type of device or system. Such devices or systems typically include one or more network interfaces for communicating over a communication network and at least one processor (e.g., a microprocessor with memory and other peripherals and/or application-specific hardware) configured accordingly to perform device or system functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth, WiFi, cellular, etc.), networking technologies, and internetworking technologies.

It should also be noted that devices and systems may use communication protocols and messages (e.g., messages created, transmitted, received, stored, and/or processed by the device or system), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

While the invention has been particularly shown and described with reference to specific embodiments, it will be understood by persons of ordinary skill in the art that various changes in form and detail may be made without departing from the spirit and scope of the invention as defined by the appended clauses. While some of these embodiments have been described in the claims by process steps, an apparatus comprising a computer capable of executing the process steps is also included in the present invention. Likewise, a computer program product comprising a tangible, non-transitory computer readable medium having embodied therein computer executable instructions for executing the process steps is included in the present invention. Data signals embodying computer program instructions and/or messages received or transmitted over a communication system are also included in the present invention. Unless the context requires otherwise, the various functions and features described herein can be used in combination even if disclosed or claimed individually. Thus, for example, it is contemplated that dependent claims included below could be rewritten into multiple dependent form to depend from the base claim and an intervening claim(s).

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The embodiments of the invention described above are intended to be merely exemplary; numerous variations and modifications will be apparent to those skilled in the art. Such variations and modifications are intended to be within the scope of the present invention as defined by any of the appended claims.

1. A network communication method comprising:
providing a point-to-point connection (“PTP connection”) between a first site and a second site, the PTP connection comprising an intermediate network device between the first and second sites, the PTP connection comprising a first link between the first site and the intermediate network device, the PTP connection comprising a second link coupled with the intermediate network device;
predicting usage of the PTP connection; and
dynamically changing, as a function of predicting usage, the PTP connection by changing one or more of the first link, the intermediate network device, and the second link.

2. The network communication method of claim 1, wherein predicting comprises at least one of:
tracking usage of the PTP connection and determining an alternative PTP connection between the first and second sites; or
using information relating to the type of data traffic to be used on the PTP connection, optionally wherein the type of data comprises bursty traffic, the method dynamically changing the PTP connection when bursty traffic and lower bandwidth traffic is predicted.

3. (canceled)

4. (canceled)

5. The network communication method of claim 1, further comprising using at least one of artificial intelligence or a mathematical model to determine an alternative PTP connection between the first and second sites.

6. (canceled)

7. The network communication method of claim 1, wherein dynamically changing comprises at least one of changing to a second intermediate network device or changing to one or more of a plurality of additional links.

8. (canceled)

9. (canceled)

10. (canceled)

11. The network communication method of claim 1, wherein at least one of:
dynamically changing comprising changing in real-time; or
the PTP-connection continues forwarding data between the first and second sites substantially without interruption during the process of dynamically changing the PTP connection.

12. (canceled)

13. The network communication method of claim 1, wherein the PTP connection is bi-directional between the first and second sites and includes a forward path and a reverse path, optionally also includes a backup forward path and a backup reverse path.

14. The network communication method of claim 1, further comprising adding a path identifier into metadata of packets to be forwarded along the PTP connection, the path identifier identifying the PTP connection, and using the path identifier by the intermediate network device to forward packets, and removing the path identifier from the metadata of packets at the intermediate network device before forwarding the packets to the destination, the destination comprising one of the first site and the second site.

15. (canceled)

16. The network communication method of claim 1, wherein a path database is used to establish and/or manage and/or provision the PTP connection.

17. (canceled)

18. The network communication method of claim 1, wherein the PTP connection is a function of one or more of geolocation information, latency information, and anycast routing.

19. (canceled)

20. The network communication method of claim 1, wherein dynamically changing comprises at least one of Dijkstra techniques or sampling PTP connection bandwidth and using Kurtosis techniques to determine that a change is desired.

21. The network communication method of claim 1, further comprising using a path of last resort when no path is available.

22. The network communication method of claim 1, wherein the PTP connection is free of IP routing between the first site and the second site.

23. The network communication method of claim 5, wherein the artificial intelligence includes embedded training data collection that receives path performance information from at least the intermediate network device and uses the path performance information for at least one of training the artificial intelligence to predict usage of the PTP connection or training the artificial intelligence to dynamically change the PTP connection, optionally wherein at least one of the path performance information is labelled for training purposes or the path performance information includes time-series information.

24. (canceled)

25. A network communication system comprising:
a path computation engine configured to form a point-to-point connection (“PTP connection”) between a first site and a second site, the PTP connection comprising an intermediate network device between the first and second sites, the PTP connection comprising a first link from the first site to the intermediate network device, the PTP connection comprising a second link from the intermediate network device; and
a prediction engine configured to predict usage of the PTP connection;
the path computation engine configured to dynamically change, as a function of the predicted usage, the PTP connection by changing one or more of the first link, the intermediate network device, and the second link.

26. The network communication system of claim 25, wherein at least one of:
the prediction engine is configured to track usage of the PTP connection and determine an alternative PTP connection between the first and second sites; or
the prediction engine is configured to use information relating to the type of data traffic to be used on the PTP connection, optionally wherein the type of data comprises bursty traffic, the path computation engine configured to dynamically change the PTP connection when bursty traffic and lower bandwidth traffic is predicted.

27. (canceled)

28. (canceled)

29. The network communication system of claim 25, wherein the path computation engine is configured to use at least one of artificial intelligence or a mathematical model to determine an alternative PTP connection between the first and second sites.

30. (canceled)

31. The network communication system of claim 25, wherein dynamically changing comprises at least one of changing to a second intermediate network device or changing to one or more of a plurality of additional links.

32. (canceled)

33. The network communication system of claim 25, wherein the PTP connection is free of IP routing between the first site and the second site.

34. The network communication system of claim 29, wherein the artificial intelligence includes embedded training data collection that receives path performance information from at least the intermediate network device and uses the path performance information for at least one of training the artificial intelligence to predict usage of the PTP connection or training the artificial intelligence to dynamically change the PTP connection, optionally wherein at least one of the path performance information is labelled for training purposes or the path performance information includes time-series information.

35. (canceled)

36. A computer program product for use on a computer system for managing a point-to-point connection, the computer program product comprising a tangible, non-transient computer usable medium having computer readable program code thereon, the computer readable program code comprising:
program code for providing a point-to-point connection (“PTP connection”) between a first site and a second site, the PTP connection comprising an intermediate network device between the first and second sites, the PTP connection comprising a first link from the first site to the intermediate network device, the PTP connection comprising a second link from the intermediate network device;
program code for predicting usage of the PTP connection; and
program code for dynamically changing, as a function of predicting usage, the PTP connection by changing one or more of the first link, the intermediate network device, and the second link.
